(19) United States
(12) Patent Application Publication
(10) Pub. No.: US 2017/0239689 A1
(43) Pub. Date: Aug. 24, 2017

(54) Mouth cleaning device

(71) Applicant: Steven D. Spearance, Lisbon, NY (US)

(72) Inventor: Steven D. Spearance, Lisbon, NY (US)

(21) Appl. No.: 15/048,681

(22) Filed: Feb. 19, 2016

(51) Int. Cl. B08B 1/00

(52) U.S. Cl. CPC B08B 1/006

(57) ABSTRACT

The oral tooth cleaning device of the present invention includes a hollow tubular member having at least one open end for the insertion of a finger. The hollow tubular member includes a microfiber, which defines its cleaning surface, such as a textured surface, configured to provide cleaning, polishing, and fresh breath to the user.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates to dental hygiene appliances. More particularly, the present invention relates to a compact, finger-mount device for cleaning the oral cavity.

(2) Background of the Invention

A tooth cleaning is regularly required to maintain dental hygiene. Various films and residues, such as plaque, can build up on teeth and gums over a period of time, thereby adversely affecting oral health. In the past, toothbrushes have been utilized to remove such films and residues. Conventional toothbrushes typically have two ends with one end being a handle and the other containing bristles designed to disrupt and remove plaque and other residues from the surfaces being cleaned.

Although conventional toothbrushes are useful in a wide variety of environments, in some circumstances, they are less than desirable. For example, some individuals desire to maintain dental hygiene by cleaning their teeth throughout the day. Unfortunately, many daily environments do not provide a setting which fosters or even allows such activity.

Moreover, travelers, army persons and those working in office environments may not find it convenient to use a toothbrush during the day. For instance, toothbrushes are not generally well-suited to be carried by persons on a day-to-day basis because of their bulky shape and the need to have access to a restroom lavatory.

In response to this desire for more frequent dental hygiene and for a cleaning device that can be easily used in public, various portable toothbrushes have been developed. In particular, a number of finger-mounted teeth cleaning devices were developed that could be placed on or over a finger and wiped over the teeth and gums. These devices are typically small, portable, and disposable.

One example of such a disposable teeth cleaning device is described in U.S. Pat. No. 3,902,509 to Tundermann et al. This device is made of a high wet strength material, such as a woven or non-woven fabric, laminated to or coated with, a water-impervious material. The water-impervious material could be a thermoplastic material, such as polypropylene. Additionally, various materials, such as flavoring materials, bacteriostats, dentifrices, or detergents could be applied to the device. To use the device, one could simply place it over a finger and rub the surface of the device over the surfaces of the teeth to remove food and plaque films.

A similar oral hygiene finger device was most recently described in U.S. Pat. No. 5,445,825 to Copelan et al. In particular, this device includes a packet of protective material that contains a membrane therein. The membrane could, for example, be made from a non-woven cellulose fiber mat with an embossed striated texture. The device described in Copelan et al. is dry and utilizes only the moisture in a user's own mouth. This packet could also be made from foil or moisture-impervious sheet plastic material.

These teeth cleaning devices, although portable, often fail to remain tightly fitted on a user's finger during cleaning. However, some finger-mounted teeth cleaning devices were developed to contain an elastomeric material that could help prevent the device from slipping or falling off the user's finger during cleaning. Examples of such teeth cleaning devices are disclosed in U.S. Pat. No. 5,068,941 to Dunn; U.S. Pat. No. 5,348,153 to Cole; U.S. Pat. No. 5,524,764 to Kaufman et al.; and PCT Publication No. WO 95/31154 to Mittiga et al. Despite the apparent benefit of such elastic teeth cleaning devices, these devices remain deficient in a variety of ways. For instance, these devices are often difficult to process using high speed manufacturing techniques, thereby necessitating higher production costs. Moreover, these devices can also fail to adequately fit onto the finger of a user, can be allergenic to a user, and in some cases, lack an aesthetically pleasing appearance. In addition, these devices are often not suitable for application with various additives useful for cleaning teeth or otherwise improving oral hygiene. Furthermore, these devices are typically not breathable nor moisture-impervious.

None of the above inventions and patents, taken either singly or in combination, is seen to describe the instant invention as claimed. Thus, a compact disposable finger-mount toothbrush of suitable material is desired for solving the aforementioned problems.

### SUMMARY OF THE INVENTION

The present invention is generally directed to an oral tooth cleaning device. The oral cleaning device includes a hollow tubular member having at least one open end for the insertion of a finger. The hollow tubular member includes a microfiber and defines a cleaning surface, such as a textured surface, configured to clean the teeth and gums of a user.

A device according to the invention for cleaning the oral cavity can be produced from various materials. In the present illustrative embodiment, the materials used are microfiber fabrics.

It is therefore an object of the present invention to provide an oral tooth cleaning device, apparatus and method which has many of the advantages of the tooth cleaning devices mentioned heretofore and many novel features that result in a new tooth cleaning device which is not anticipated, rendered obvious, suggested, or even implied by any of the prior art tooth cleaning devices, either alone or in any combination thereof.

It is another object of the present invention to provide an oral tooth cleaning device which is used with water or simply alone.

It is a further object of the present invention to provide an oral tooth cleaning device which is of a durable and reliable construction.

An even further object of the present invention is to provide an oral tooth cleaning device which is susceptible of a low cost of manufacture with regard to both materials and labor, and which accordingly is then susceptible of low prices of sale to the consuming public, thereby making such tooth cleaning device economically available to the buying public.

Still yet another object of the present invention is to provide an improved tooth cleaning device which provides in the apparatuses and methods of the prior art some of the advantages thereof, while simultaneously overcoming some of the disadvantages normally associated therewith.

Still another object of the present invention is to provide an improved oral tooth cleaning device for cleaning teeth of plaque without using a toothbrush having bristles thereon.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of an oral tooth cleaning device according to one embodiment of the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical and electrical changes may be made without departing from the spirit and scope of the present invention. The following detailed description is, therefore, not to be taken in a limiting sense, and the scope of the present invention is defined by the appended claims and their equivalents.

In general, the present invention is directed to an oral tooth cleaning device that can be more easily used during the day than toothbrushes. In particular, the present invention is directed to an oral tooth cleaning device that can fit onto a human finger so that the teeth or gums of a person can be cleaned by simply contacting the wipe therewith. For instance, the tooth cleaning device of the present invention can be used by an individual to clean one's teeth or to clean the teeth of someone else, such as an infant, or an elderly person. Further, the tooth cleaning device is well suited for every user irrespective of his/her age.

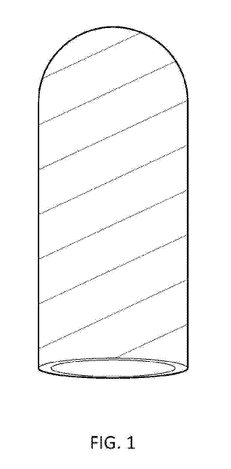

Referring to FIG. 1, various embodiments of an oral tooth cleaning device made in accordance with the present invention are depicted. In general, an oral tooth cleaning device of the present invention can be used to clean the oral cavity of a user by inserting it into a finger and maneuvering it within the oral cavity. In particular, as shown in FIG. 1, an oral tooth cleaning device provides cleaning, polishing, and fresh breath to the user.

An oral tooth cleaning device of the present invention, as shown in FIG. 1 can generally be formed in a variety of ways. For instance, in one embodiment, the oral tooth cleaning device includes a hollow tubular member having at least one open end for the insertion of a finger. The hollow tubular member includes a microfiber, which defines its cleaning surface, such as a textured surface, configured to clean the teeth and gums of a user. In another instance, the length of the tubular member is about 1.5 inches and its breath is about ¾ inches in which future changes are depending upon their particular application.

This invention is clearly new and useful. Moreover, it was not obvious to those of ordinary skill in this art at the time it was made, in view of the prior art when considered as a whole in accordance with the requirements of law.

It will thus be seen that the objects set forth above, and those made apparent from the foregoing description, are efficiently attained and since certain changes may be made in the above construction without departing from the scope of the invention, it is intended that all matters contained in the foregoing construction or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

1. (canceled)

2. (canceled)

3. (canceled)

4. (canceled)

5. (canceled)

6. (canceled)

7. (canceled)

8. An oral tooth cleaning device, comprising:
a) a tubular member, having a first closed end, and an second open end being opposite to the first closed end, wherein the tubular member is of sufficient size to retain a finger of a user; and
b) a cleaning surface, located on an outside surface of the tubular member, and extending from the first closed end to the second open end.

9. The oral tooth cleaning device of claim 8, wherein the cleaning surface comprises a plurality of microfibers having a plurality of vertical aligned micro filaments that are spaced apart from each other and extend from the outside surface of the tubular member a equal distance for each micro filament of the plurality of vertical aligned micro filament.

10. The oral tooth cleaning device of claim 9, wherein the tubular member has a thickness sufficient to support the plurality of microfibers.

11. The oral tooth cleaning device of claim 9, wherein plurality of microfibers have a thickness sufficient to withstand an oral cavity cleaning activity.
